(19) United States
(12) Patent Application Publication
(10) Pub. No.: US 2012/0317159 A1
(43) Pub. Date: Dec. 13, 2012

(54) MODULAR OPERATOR, DEVICE HAVING THE SAME, AND OPERATING METHOD THEREOF

(75) Inventors: Kyoung Moon Ahn, Seoul (KR); Jong Hoon Shin, Hwaseong-si (KR); Ji-Su Kang, Seoul (KR); Sun-Soo Shin, Seoul (KR)

(73) Assignee: SAMSUNG ELECTRONICS CO., LTD., Suwon-si (KR)

(21) Appl. No.: 13/451,815

(22) Filed: Apr. 20, 2012

(30) Foreign Application Priority Data
Jun. 10, 2011 (KR) 10-2011-0055901

(51) Int. Cl. G06F 7/48; G06F 5/01

(52) U.S. Cl. 708/209

(57) ABSTRACT

A modular operator, a smart card including the same, and a method of operating the same are provided. The modular operator includes: an input unit configured to receive first data, second data, and a modulus; and an accumulator configured to perform an accumulation operation on the first data and a first portion of the second data, to shift the accumulation operation result to the right as much as the number of bits of the first portion, and to perform an accumulation operation on a result of a shifted accumulation operation, a second part, of the second data, which is shifted to the right as much as the number of bits of the first portion, and the modulus.

### CROSS-REFERENCE TO RELATED APPLICATION

This application claims priority under 35 U.S.C. §119(a) from Korean Patent Application No. 10-2011-0055901, filed on Jun. 10, 2011 in the Korean Intellectual Property Office, the disclosure of which is hereby incorporated by reference in its entirety.

### BACKGROUND

Apparatuses and methods consistent with exemplary embodiments relate to a modular operator, and more particularly, a modular operator with a fast processing speed, a device having the same, and an operating method thereof.

An encryption algorithm used in public-key encryption/decryption and/or a digital signature system is a public key cryptosystem introduced by Diffie-Hellman, a cryptosystem of Taher Elgamal based on a Discrete Logarithm Problem, or a Revest Shamir Adleman cryptosystem based on a prime factorization problem.

Such cryptosystems perform encryption and decryption by using a modular operation. For example, in a modular operation expressed as X mod M=Z, X is an operand, M is modulus and Z is a remainder. The remainder Z is a remainder calculated by dividing the operand X by the modulus M. For example, in case of 27 mod 10=7, a remainder calculated by dividing 27 by 10 is 7.

The modular operation includes a modular addition, a modular subtraction, a modular multiplication, a modular division and a modular involution.

When the modular operation is performed by a general processor embodied in a smart card, a performance deterioration caused by a longer processing time occurs. As a solution for this, embodying hardware performing a modular operation in a cryptosystem such as a smart card may improve performance.

### SUMMARY

According to an aspect of an exemplary embodiment, there is provided a modular operator, including: an input unit configured to receive first data, second data and a modulus; and an accumulator configured to perform an accumulation operation on the first data and a first portion of the second data, to shift the accumulation operation result to the right as much as the number of bits of the first portion, and to perform an accumulation operation on a result of the shifted accumulation operation, a second portion, of the second data, which is shifted to the right as much as the number of bits of the first portion, and the modulus.

The first data may be an augend or a minuend, and the second data may be an addend or a subtrahend.

The first portion may include lower digits of the second data, and the second portion may include upper digits of the second data.

According to an aspect of another exemplary embodiment, there is provided a smart card, including: the modular operator; and a processor controlling the modular operator.

The modular operator may include a modular multiplier, and the processor may perform a modular addition or a modular subtraction operation by using the modular multiplier.

The modular operator may determine whether to add or to subtract the modulus according to a sign bit of the first data, a sign bit of the second data, and one of a modular addition and a modular subtraction.

The modular operator, when performing the modular addition, may set to subtract the modulus from a sum of the first data and the second data when sign bits of the first data and the second data are plus, may set to add the modulus to the sum when the sign bits of the first data and the second data are minus, and may set not to add or subtract the modulus to or from the addition when a sign bit of the first data is different from a sign bit of the second data.

The modular operator, when performing the modular subtraction, may set not to add or subtract the modulus to or from a difference between the first data and the second data when a sign bit of the first data is the same as a sign bit of the second data, may set to subtract the modulus from the difference when a sign bit of the first data is plus and a sign bit of the second data is minus, and may set to add the modulus to the difference when a sign bit of the first data is minus and a sign bit of the second data is plus.

According to an aspect of another exemplary embodiment, there is provided a method of operating a modular operator, the method including: receiving first data and second data; performing an accumulation operation on the first data and a first portion of the second data and receiving a modulus; shifting the accumulation operation result and a second portion of the second data to the right as much as the number of bits of the first portion; and performing an operation on the accumulation operation result and the second portion, which are shifted, respectively, and the modulus.

The method may further include determining whether to add or subtract the modulus according to a sign bit of the first data, a sign bit of the second data, and one of a modular addition and a modular subtraction.

According to an aspect of another exemplary embodiment, there is provided a method of operating a modular operator, the method including: shifting data corresponding to a result of an accumulation operation on first data and a first portion of second data, and shifting a second portion of the second data to the right as much as the number of bits of the first portion; and performing a second accumulation operation on the shifted data, the shifted second portion, and a modulus.

### BRIEF DESCRIPTION OF THE DRAWINGS

These and/or other aspects and advantages will become apparent and more readily appreciated from the following description of exemplary embodiments, taken in conjunction with the accompanying drawings of which:

FIG. 1 is a block diagram illustrating a smart card according to an example embodiment;

FIG. 2 is a block diagram illustrating a modular operator illustrated in FIG. 1 in detail;

FIG. 3 is a block diagram illustrating an accumulator illustrated in FIG. 2 in detail;

FIG. 4 is a flowchart illustrating an operation of the modular operator illustrated in FIG. 1;

FIG. 5 is a conceptual diagram illustrating an operation of the modular operator illustrated in FIG. 4;

FIG. 6 is a block diagram illustrating the modular operator according to another example embodiment;

FIG. 7 is an example embodiment of a computer system including the modular operator illustrated in FIG. 1 or 6;

FIG. 8 is another example embodiment of the computer system including the modular operator illustrated in FIG. 1 or 6; and

FIG. 9 is still another example embodiment of the computer system including the modular operator illustrated in FIG. 1 or 6;

### DETAILED DESCRIPTION OF EXEMPLARY EMBODIMENTS

Exemplary embodiments will now be described more fully hereinafter with reference to the accompanying drawings. Exemplary embodiments may, however, be embodied in many different forms and should not be construed as limited to the exemplary embodiments set forth herein. Rather, these exemplary embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc., may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Aspects of exemplary embodiments provide a modular operator or a modular calculator performing a modular addition or a modular subtraction during a short period of time by using a modular multiplier.

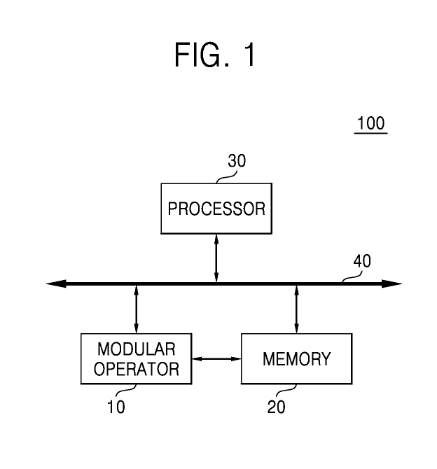

FIG. 1 is a block diagram illustrating a smart card 100 according to an example embodiment. Referring to FIG. 1, the smart card 100 includes a modular operator 10, a memory 20, a processor 30, and a bus 40.

For convenience of explanation, FIG. 1 illustrates the smart card 100 as an example of a device including the modular operator 10. However, example embodiments may be applied to other devices including the modular operator 10, and are not limited to a smart card 100.

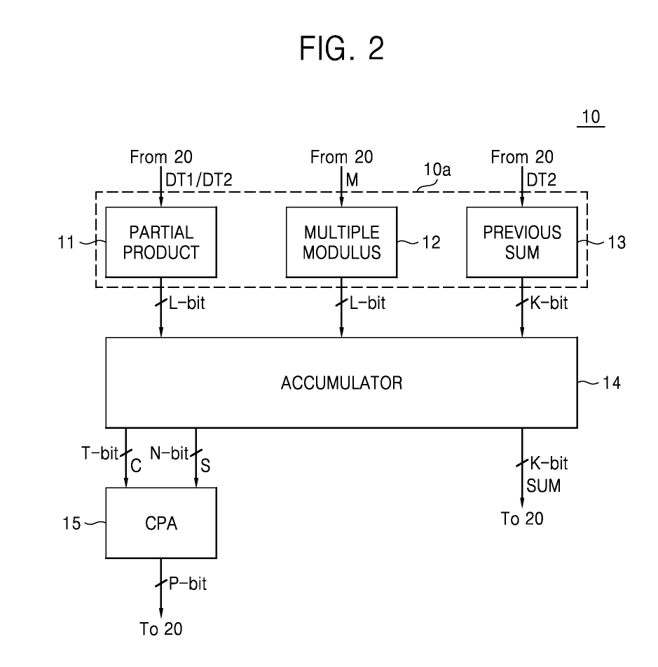

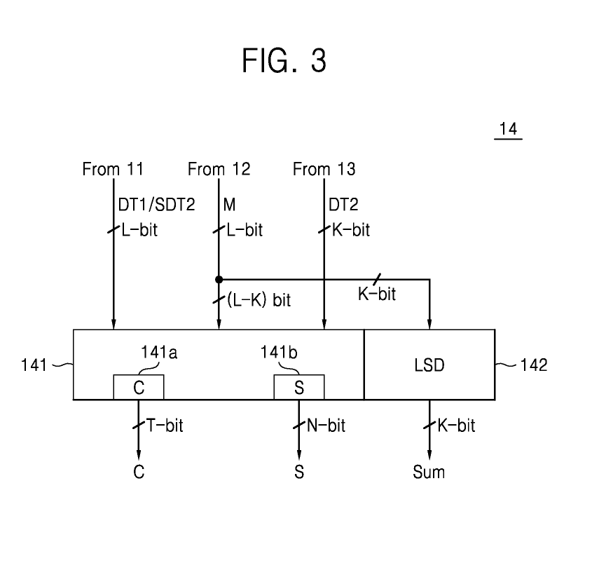

The modular operator 10 is hardware for performing a public key algorithm such as Revest, Shamir and Adleman (RSA), a digital signature algorithm (DSA) or an elliptic curve cryptosystem (ECC). As an example, the modular operator 10 is embodied in a modular multiplier. The modular operator 10 performs a modular addition and/or a modular subtraction operation by using a modular multiplier during a short period of time. The modular operator 10 is explained in detail below with reference to FIGS. 2 and 3.

The memory 20 stores a multiplier, an addend, a subtrahend, a multiplicand, an augend, a minuend and/or a modulus to perform the modular multiplication, the modular addition and/or the modular subtraction.

As an example, the memory 20 may be embodied in a volatile memory device such as a dynamic random access memory (DRAM), a static random access memory (SRAM), a thyristor RAM (T-RAM), a zero capacitor RAM (Z-RAM), a Twin Transistor RAM (TTRAM), etc.

In addition, the memory 20 may be embodied in a non-volatile memory device such as an Electrically Erasable Programmable Read-Only Memory (EEPROM), a flash memory, a Magnetic RAM (MRAM), a Spin-Transfer Torque MRAM, a Conductive bridging RAM (CBRAM), a Ferroelectric RAM (FeRAM), a Phase change RAM (PRAM), a Resistive RAM (RRAM or ReRAM), a Nanotube RRAM, a Polymer RAM (PoRAM), a Nano Floating Gate Memory (NFGM), a holographic memory, a Molecular Electronics Memory Device, an Insulator Resistance Change Memory, etc.

The modular operator 10 may include a memory interface or a memory controller for controlling the memory 20.

The processor 30 controls the modular operator 10 and the memory 20. The bus 40 connects the modular operator 10, the memory 20 and the processor 30 to one another.

FIG. 2 is a block diagram illustrating the modular operator 10 illustrated in FIG. 1 in detail. Referring to FIGS. 1 and 2, the modular operator 10 includes an input unit 10a, an accumulator 14, and an adder 15. The input unit 10a includes a first register 11, a second register 12 and a third register 13.

For example, the first register 11 receives an L-bit first data DT1 and an L-bit second data DT2 from the memory 20 (where L is a natural number), and outputs the received data DT1 and DT2 in a shifted form or a non-shifted form. The second register 12 receives an L-bit modulus M from the memory 20.

The first data DT1 is an augend or a minuend, and the second data DT2 is an addend or a subtrahend. The third register 13 processes an L-bit previous sum PS when performing a modular multiplication operation, and receives a second data DT2 more than k bits from the memory 20 when performing a modular addition operation or a modular subtraction operation.

The accumulator 14 accumulates one of the L-bit first data DT1 and a shifted L-bit second data SDT2 of FIG. 3 transmitted from the first register 11, an L-bit modulus M transmitted from the second register 12, and a K-bit second data DT2 transmitted from the third register 13. Furthermore, the accumulator 14 transmits a carry C and a sum S to the adder 15.

Additionally, the accumulator 14 transmits a lower bit sum SUM of K bits or a lower digit sum SUM of K bits to the memory 20 through the bus 40 as a result of an accumulation operation on a lower bit or a lower digit.

The adder 15 receives a carry value C of T bit, where T is a natural number, and a sum value S of N bit, where N is a natural number, transmitted from the accumulator 14. The adder 15 outputs an operation result of P bit, where P is a natural number, to the memory 20 through the bus 40. As an example, the adder 15 may be embodied in a carry propagate adder (CPA).

FIG. 3 is a block diagram illustrating the accumulator 14 illustrated in FIG. 2 in detail. Referring to FIGS. 1 to 3, the accumulator 14 includes an accumulation operator 141 and a lower digit operator 142.

The accumulation operator 141 has two types of input combinations. One type of input combination accumulates an L-bit first data DT1 transmitted from the first register 11 and a K-bit second data DT2 transmitted from the third register 13. The other type of input combination accumulates an accumulation operation result shifted to the right as much as k bits, a shifted L-bit second data SDT2 transmitted from the first register 11, and a (L-K) bit modulus M transmitted from the second register 12.

The accumulation operator 141 includes a carry register 141a for storing a carry value C and a sum register 141b storing a sum value S.

The lower digit operator 142 performs an accumulation operation on a K-bit modulus M transmitted from the second register 12 and an accumulation operation result shifted as much as K bits from the accumulation operator 141. For example, the second register 12 transmits an (L-K)-bit modulus M, which is upper bits of an L-bit modulus M, to the accumulation operator 141. The second register 12 transmits a K-bit modulus M, which is lower bits of the L bit modulus M, to the lower digit operator 142. Moreover, the accumulation operator 141 shifts the accumulation operation result to the lower digit operator 142 as much as K bits.

The lower digit operator 142 performs an accumulation operation on a K-bit modulus M transmitted from the second register 12 and an accumulation operation result shifted as much as K bits by the accumulation operator 141. As a result, the lower digit operator 142 outputs a K-bit lower digit sum SUM.

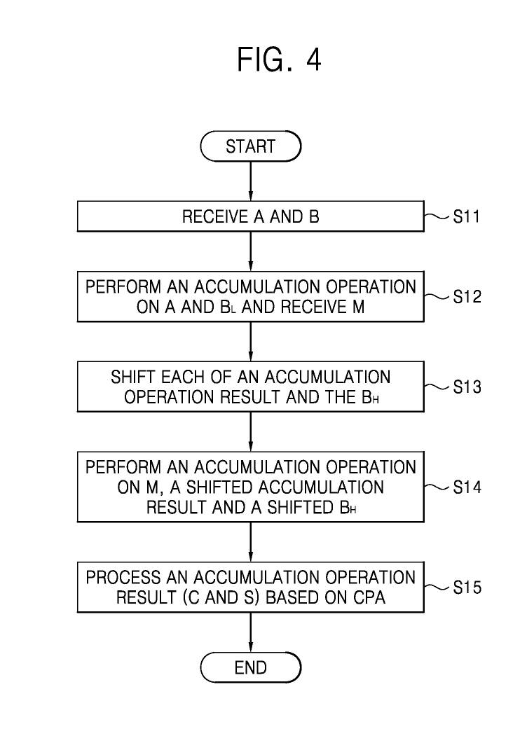

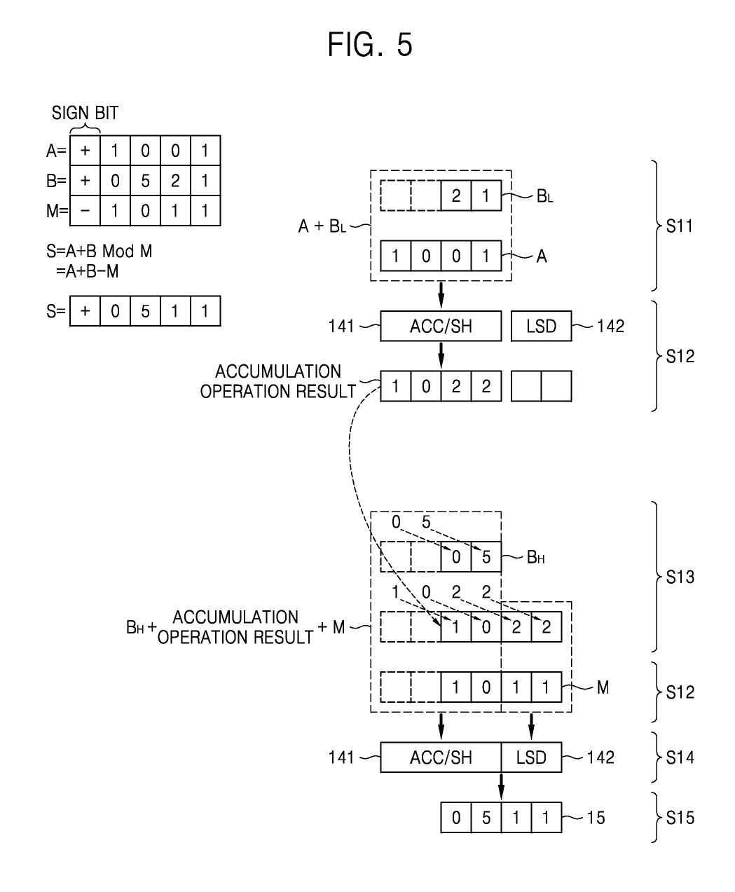

FIG. 4 is a flowchart illustrating an operation of the modular operator 10 illustrated in FIG. 1, and FIG. 5 is a conceptual diagram illustrating an operation of the modular operator 10 described with reference to FIG. 4. Referring to FIGS. 1 to 5, for example, it is assumed that the modular operator 10 operates S=A+B Mod M, where A and B are positive integers and S is a result value.

A first integer A is an augend or a minuend. B is an addend or a subtrahend. M is a modulus. It is assumed that L is 4 and K is 2. In addition, the first integer A, the second integer B, and the modulus M are assumed to include a sign bit and a four-digit decimal. In addition, a sign bit “0” denotes plus and a sign bit “1” denotes minus.

Each sign bit of the first integer A and the second integer B and a modular addition or a modular subtraction operation are used to determine whether to add or subtract a modulus M. For convenience of explanation, each sign bit of the first integer A, the second integer B, and the modulus M is not illustrated. Here, the first integer A is 1001, the second integer B is 0521, and the modulus M is 1011.

The first register 11 receives the first integer A and the third register 13 receives lower two digits B_{L} of the second integer B (operation S11). The accumulator 14 performs an accumulation operation on the first integer A and the lower two digits B_{L} of the second integer B, and the second register 12 receives the modulus M (operation S12).

The lower two digits B_{L} of the second integer B is 21, and upper two digits B_{H} of the second integer B is 05. The accumulation operator 141 perform an accumulation operation on the first integer A and the lower two digits B_{L} of the second integer B. The accumulation operation result is 1022.

The upper two digits B_{H}=05 of the second integer B is shifted to the right as much as the number of digits of the lower two digits B_{L} of the second integer B, and input to the accumulation operator 141 (operation S13). The accumulation operator 141 shifts the accumulation operation result 1022 to the right as much as the number of digits of the lower two digits B_{L} of the second integer B. Here, the lower two digits B_{L} of the second integer B is 21, so the number of bits of the lower two digits B_{L} of the second integer B is 2. Accordingly, the accumulation operation result 1022 and the upper two digits B_{H}=05 of the second integer B are shifted to the right as much as two digits, respectively.

The accumulator 14 performs an accumulation operation on the modulus M, the shifted accumulation operation result 1022, and the shifted upper two digits B_{H}=05 of the second integer B (operation S14).

Since both the first integer A and the second integer B are positive integers, each sign bit of the first integer A and the second integer B is 0, e.g., plus. In a modular addition, since each signal bit of the first integer A and the second integer B is plus, an addition of the first integer A and the second integer B may be greater than a modulus M. Accordingly, the modulus M should be subtracted from the addition of the first integer A and the second integer B. That is, A+B Mod M becomes A+B−M. A+B Mod M is a value calculated by subtracting the modulus M from the addition of the first integer A and the second integer B.

For example, the accumulation operator 141 performs an accumulation operation on 05 which is the upper two digits B_{H} of the shifted second integer B, 10 which is the upper two digits of the shifted accumulation operation result 1022, and 10 which is the upper two digits of the modulus M. As a result, the accumulation operator 141 outputs 05. In this case, a carry value C of the accumulation operator 141 is 0, and a sum value S of the accumulation operator 141 is 5.

The lower digit operator 142 performs an accumulation operation on 22 which is the lower two digits of the shifted accumulation operation result, for example 1022, and 11 which is the lower two digits of the modulus M, for example 1011. As a result, the lower digit operator 142 outputs 11 which is a lower digit sum SUM of the lower digit operator 142.

The adder 15 receives the carry value C and the sum value S from the accumulation operator 141 and adds the carry value C and the sum value S (operation S15). The modular operator 10 determines whether to add or subtract the modulus M according to a sign bit of the first integer A, a sign bit of the second integer B, and a kind of a modular operation. Each of an equation 1 and an equation 2, shown below, indicates a state adding or subtracting the modulus M to/from a modulus addition or a modulus subtraction.

The equation 1 shows a method determining a process adding or subtracting a modulus M to/from a modulus addition. For example, each of A and B in equation 1 and equation 2 is greater than or equal to a negative modulus −M and smaller than a positive modulus M. Accordingly, each range of the first integer A and the second integer B is determined as shown in equation 1. Accordingly, the accumulator 14 performs a modular operation on addition of the first integer A and the second integer B, i.e., an arithmetical operation on A+B and a modulus M, as shown in equation 1, and outputs a result value S.

[Equation 1]

−M≦A<0,−M≦B<0->S=A+B+M(−M≦S<M) 1)

−M≦A<0,0≦B<M->S=A+B(−M≦S<M) 2)

0≦A<M,−M≦B<0->S=A+B(−M≦S<M) 3)

0≦A<M,0≦B<M->S=A+B−M(−M≦S<M) 4)

Equation 2 shows a method of determining a process adding or subtracting a modulus M to/from a modulus subtraction.

When the accumulator 14 performs a modular operation on subtraction between the first integer A and the second integer B, each range of the first integer A and the second integer B is determined as shown in equation 2. It is still assumed that each of the first integer A and the second integer B is greater than or equal to a negative modulus −M and smaller than a positive modulus M. Accordingly, the accumulator 14 performs a modular operation on subtraction between the first integer A and the second integer B, i.e., an arithmetical operation on A-B and a modulus M, as shown in equation 2, and outputs a result value S.

[Equation 2]

−M≦A<0,−M≦B<0->S=A−B(−M<S<M) 1)

−M≦A<0,0≦B<M->S=A−B+M(−M<S<M) 2)

0≦A<M,−M≦B<0->S=A−B−M(−M<S<M) 3)

0≦A<M,0≦B<M->S=A−B(−M<S<M) 4)

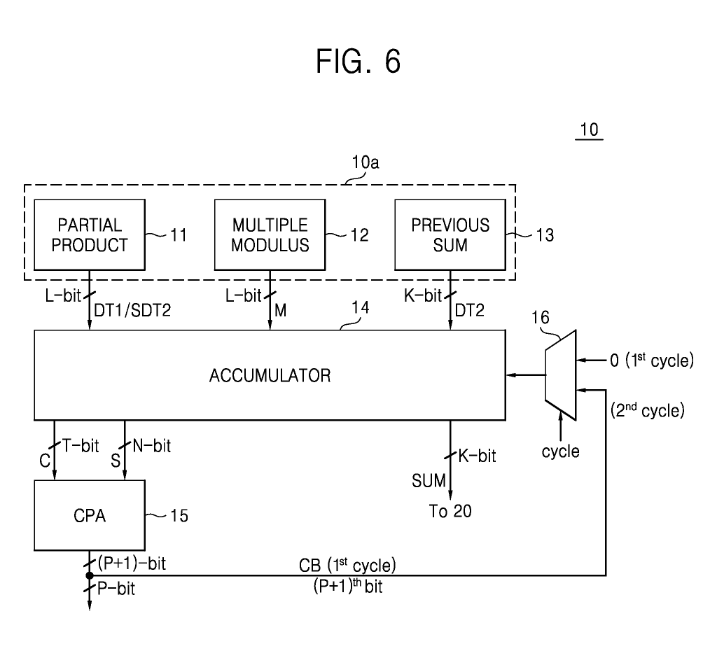

FIG. 6 is a block diagram illustrating a modular operator 10 according to another example embodiment. Referring to FIGS. 1 and 6, the modular operator 10 is similar to the modular operator 10 illustrated in FIG. 2. For convenience of explanation, explanations of identical or substantially similar blocks are omitted.

A first data DT1, a second data DT2, and a modulus M which are input to the modular operator 10 are 2L bits.

A multiplexer 16 transmits 0 to the accumulator 14 during a first cycle. The multiplexer 16 transmits a carry/borrow CB which is a (P+1)^{th} bit of the adder 15 to the accumulator 14 during a second cycle. Accordingly, the accumulator 14 performs an operation on a lower L-bit first data DT1, a lower L-bit second data DT2, and a lower L-bit modulus M during a first cycle. Subsequently, the adder 15 outputs a P-bit first accumulation operation result to the memory 20 and transmits a single bit, i.e., a (P+1)^{th} bit, carry/borrow CB to the multiplexer 16.

Moreover, the accumulator 14 performs an operation on an upper L-bit first data DT1, an upper L-bit second data DT2, and an upper L-bit modulus M during a second cycle 2^{nd} cycle. Subsequently, the adder 15 transmits a P-bit second accumulation operation result to the memory 20.

The processor 30 receives a P-bit first accumulation operation result and a P-bit second accumulation operation result. The processor 30 generates a 2P-bit accumulation operation result by using the P-bit first accumulation operation result and the P-bit second accumulation operation result.

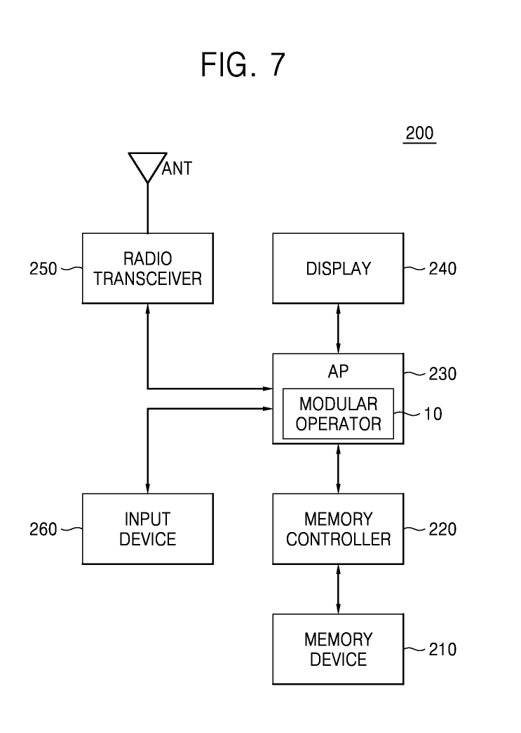

FIG. 7 is an example embodiment of a computer system 200 including the modular operator 10 illustrated in FIG. 1. Referring to FIG. 7, the computer system 200 may be embodied in a cellular phone, a smart phone, a personal digital assistant (PDA), a smart pad, a wireless communication device, a personal computer, a tablet, a laptop computer, etc.

The computer system 200 includes a memory device 210 and a memory controller 220 controlling an operation of the memory device 210. An application processor 230 includes the modular operator 10 illustrated in FIG. 1. The memory controller 220 may control a data access operation of the memory device 210, e.g., a write operation or a read operation, according to a control of the application processor 230. Data stored in the memory device 210 may be displayed through a display 240 according to a control of the application processor 230 and the memory controller 220. A radio transceiver 250 may transmit or receive a radio signal through an antenna ANT.

For example, the radio transceiver 250 may convert a radio signal received through the antenna ANT into a signal which may be processed by the application processor 230. Accordingly, the application processor 230 may process a signal output from the radio transceiver 250 and transmit a processed signal to the memory controller 220 or the display 240. The memory controller 220 may store a signal processed by the application processor 230 in the memory device 210.

The radio transceiver 250 may also convert a signal output from the application processor 230 into a radio signal and output a converted radio signal to an external device through the antenna ANT. An input device 260 is a device which may input a control signal for controlling an operation of the application processor 230 or data to be processed by the application processor 230, and may be embodied in a pointing device such as a touch pad, a computer mouse, a keypad, a keyboard, etc.

The application processor 230 may control an operation of the display 240 so that data output from the memory controller 220, data output from the radio transceiver 250, and data output from the input device 260 may be displayed through the display 240. According to an example embodiment, the memory controller 220 controlling an operation of the memory device 210 may be embodied in a part of the application processor 230 or a separate chip from the application processor 230.

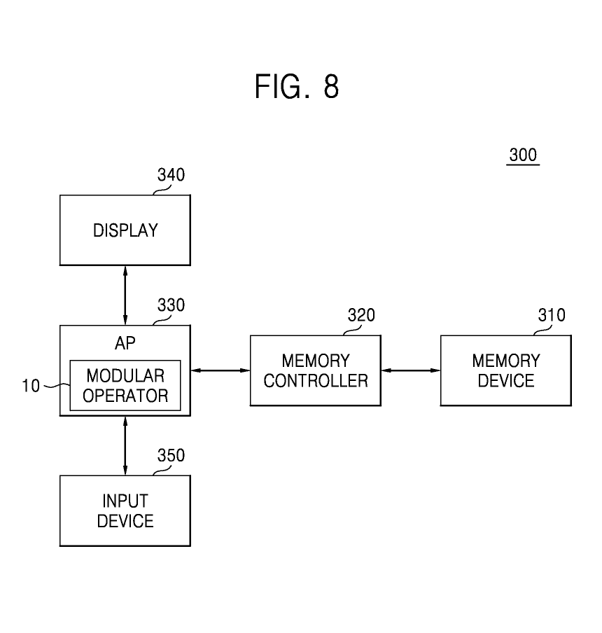

FIG. 8 is another example embodiment of a computer system 300 including the modular operator 10 illustrated in FIG. 1. Referring to FIG. 8, a computer system 300 may be embodied in a personal computer (PC), a network server, a tablet PC, a net-book, an e-reader, a personal digital assistant (PDA), a portable multimedia player (PMP), an MP3 player, an MP4 player, a laptop computer, etc.

The computer system 300 includes an application processor 330, a memory device 310, a memory controller 320 which may control an operation of the memory device 310, a display 340, and an input device 350.

The application processor 330 includes the modular operator 10 illustrated in FIG. 1. The application processor 330 may display data stored in the memory device 310 through the display 340 according to data input through the input device 350. For example, the input device 350 may be embodied in a pointing device such as a touch pad, a computer mouse, a keypad, a keyboard, etc. The application processor 330 may control a whole operation of the computer system 300 and control an operation of the memory controller 320.

According to an example embodiment, the memory controller 320 controlling an operation of the memory device 310 may be embodied in a part of the application processor 330 or a separate chip from the application processor 330.

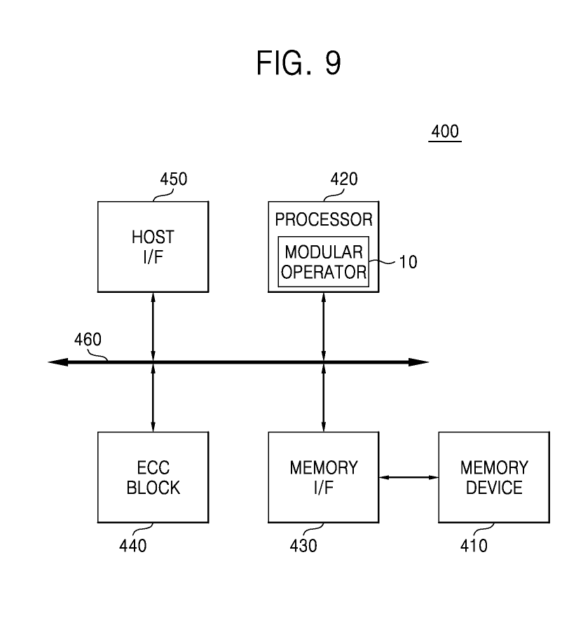

FIG. 9 is still another example embodiment of a computer system 400 including the modular operator 10 illustrated in FIG. 1. Referring to FIG. 9, a computer system 400 includes a memory device 410 and a processor 420 which may control an operation of the memory device 410.

The processor 420 includes the modular operator 10 illustrated in FIG. 1. It is illustrated that the memory device 410 is embodied in a non-volatile memory such as a NAND flash memory. The computer system 400 further includes a memory interface 430, an error correction code (ECC) block 440 and a host interface 450.

A host (not shown) connected to the computer system 400 may perform data communication with the memory device 410 through the memory interface 430 and the host interface 450.

According to a control of the processor 420, the error correction code block 440 may detect an error bit included in data output from the memory device 410 through the memory interface 430, correct the error bit, and transmit error bit-corrected data to a host through the host interface 450. The processor 420 may control data communication among the memory interface 430, the error correction code block 440, and the host interface 450 through a bus 460.

The computer system 400 may be embodied in a flash memory drive, a USB memory drive, an IC-USB memory drive, a memory stick, etc.

A modular operator according to an example embodiment may be embodied in a small size, and has a fast processing speed and extensity.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs.

Although a few exemplary embodiments have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A modular operator comprising:
an input unit configured to receive first data, second data, and a modulus; and
an accumulator configured to perform a first accumulation operation on the received first data and a first portion of the received second data, to shift a result of the performed first accumulation operation to the right as much as the number of bits of the first portion, and to perform a second accumulation operation on the shifted result of the first accumulation operation, a second portion, of the received second data, which is shifted to the right as much as the number of bits of the received first portion, and the received modulus.

2. The modular operator of claim 1, wherein the received first data is an augend or a minuend, and the received second data is an addend or a subtrahend.

3. The modular operator of claim 1, wherein the first portion includes lower digits of the received second data and the second portion includes upper digits of the received second data.

4. The modular operator of claim 1, further comprising an adder which receives a carry value of the performed second accumulation operation and a sum value of the performed second accumulation operation, and adds the received carry value and the received sum value.

5. A smart card comprising:
the modular operator of claim 1; and
a processor controlling the modular operator.

6. The smart card of claim 5, wherein the received first data is an augend or a minuend, and the received second data is an addend or a subtrahend.

7. The smart card of claim 5, wherein the first portion comprises lower digits of the received second data and the second portion comprises upper digits of the received second data.

8. The smart card of claim 5, wherein the modular operator comprises a modular multiplier.

9. The smart card of claim 8, wherein the processor performs at least one of a modular addition operation and a modular subtraction operation by using the modular multiplier.

10. The smart card of claim 9, wherein the modular operator determines whether to add or to subtract the received modulus based on a sign bit of the received first data, a sign bit of the received second data, and one of a modular addition and a modular subtraction.

11. The smart card of claim 10, wherein the modular operator, when performing the modular addition, sets to subtract the received modulus from a sum of the received first data and the received second data when sign bits of the received first data and the received second data are plus,
sets to add the received modulus to the sum when the sign bits of the received first data and the received second data are minus, and
sets not to add or subtract the received modulus to or from the sum when the sign bit of the received first data is different from the sign bit of the received second data.

12. The smart card of claim 10, wherein the modular operator, when performing the modular subtraction, sets not to add or subtract the received modulus to or from a difference between the received first data and the received second data when a sign bit of the received first data is equal to a sign bit of the received second data,
sets to subtract the received modulus from the difference when the sign bit of the received first data is plus and the sign bit of the received second data is minus, and
sets to add the received modulus to the difference when the sign bit of the received first data is minus and the sign bit of the received second data is plus.

13. A computer system comprising:
the modular operator of claim 1; and
a processor controlling the modular operator.

14. A method of operating a modular operator, the method comprising:
receiving, first data, second data, and a modulus;
performing a first accumulation operation on the received first data and a first portion of the received second data;
shifting a result of the performed first accumulation operation and a second portion of the received second data to the right as much as the number of bits of the first portion; and
performing a second accumulation operation on the shifted result of the performed first accumulation operation, the shifted second portion, and the received modulus.

15. The method of claim 14, further comprising:
determining whether to add or subtract the received modulus according to a sign bit of the received first data, a sign bit of the received second data, and one of a modular addition and a modular subtraction.

16. The method of claim 14, wherein the receiving, the performing the first accumulation operation, the shifting, and the performing the second accumulation operation are performed by a smart card.

17. A method of operating a modular operator, the method comprising:
shifting data corresponding to a result of an accumulation operation on first data and a first portion of second data, and shifting a second portion of the second data to the right as much as the number of bits of the first portion; and
performing a second accumulation operation on the shifted data, the shifted second portion, and a modulus.

18. The method of claim 17, wherein the received first data is an augend or a minuend, and the received second data is an addend or a subtrahend.

19. A computer-readable recording medium having recorded thereon a program executable by a computer for performing the method of claim 14.

20. A computer-readable recording medium having recorded thereon a program executable by a computer for performing the method of claim 17.
